(19) United States
(12) Patent Application Publication
(10) Pub. No.: US 2021/0362742 A1
(43) Pub. Date: Nov. 25, 2021

(54) ELECTRONIC DEVICE FOR VEHICLES

(71) Applicant: LG Electronics Inc., Seoul (KR)

(72) Inventors: Taekyung LEE, Seoul (KR); Junyoung YU, Seoul (KR); Sangyol YOON, Seoul (KR); Soojung JEON, Seoul (KR)

(21) Appl. No.: 16/500,922

(22) PCT Filed: Jul. 3, 2019
(86) PCT No.: PCT/KR2019/008125

§ 371 Date: Oct. 4, 2019

(51) Int. Cl. B60W 60/00; G05D 1/02; B60W 30/18; H04W 4/44; H04W 4/24; G07C 5/00; G06Q 20/12; G06Q 30/02; G07B 15/06; G01C 21/34

(52) U.S. Cl. CPC B60W 60/005; H04W 84/042; B60W 30/18163; B60W 60/001; H04W 4/44; H04W 4/24; G07C 5/008; G06Q 20/127; G06Q 30/0284; G07B 15/063; G01C 21/3461; B60W 2556/45; B60W 2555/60; B60W 2552/05; B60W 2554/40; B60W 2555/20; G05D 2201/0213; G05D 1/0285

(57) ABSTRACT

Disclosed is an electronic device for vehicles including a processor configured to transmit and receive information to and from an external server that supports an autonomous traveling service based on 5G communication in a sensor autonomous traveling mode or in a communication autonomous traveling mode and to switch to an integrated mode in which an autonomous traveling control signal is generated based on a possible autonomous traveling function of an ego vehicle based on sensor data and an auxiliary autonomous traveling function that assists the possible autonomous traveling function of an ego vehicle or an additional autonomous traveling function that is additionally required.

### TECHNICAL FIELD

The present disclosure relates to an electronic device for vehicles, and more particularly to an electronic device that supports an autonomous traveling function for an autonomous vehicle using a 5G communication system that supports a higher data transfer rate than a 4G communication system, such as LTE.

### BACKGROUND ART

A vehicle is an apparatus that moves a passenger in a direction in which the passenger wishes to go, and a representative example of the vehicle is a car. An autonomous vehicle means a vehicle capable of automatically traveling without human manipulation.

Meanwhile, 5G communication is a mobile communication service that has a maximum speed of up to 20 Gbps, which is about 20 times as fast as the maximum speed (1 Gbps) of LTE, which is the previous generation, and that has processing capacity 100 times as large thereas. 5G communication has the advantage of ultra-low latency (a latency of 1 ms) and ultra-connectivity, based on which autonomous traveling may be realized. Consequently, research thereon has been actively conducted.

Conventionally, possible functions, performance, and stability are fixed depending on the autonomous traveling level of a vehicle. That is, vehicle state, traveling environment, etc. are sensed using only a sensor of the vehicle, whereby a recognizable area and accuracy are limited. For example, in the case in which the autonomous traveling level is level 3, lane change and overtaking on an expressway are possible. Since it is not possible to correspond to various road conditions and driving situations using only the sensor, however, autonomous traveling in a downtown area is limited.

Therefore, there is a necessity for an improved system and device capable of providing a function upgraded from an existing autonomous traveling function or improved traveling performance by exchanging data through communication even without separately purchasing a higher-level autonomous vehicle or replacing the sensor with a high-performance sensor.

### DISCLOSURE

### Technical Problem

The present disclosure has been made in view of the above problems, and it is an object of the present disclosure to provide an electronic device for vehicles capable of improving the autonomous traveling level of a vehicle, which is fixed conventionally, using 5G communication.

It is another object of the present disclosure to provide an electronic device for vehicles capable of improving traveling performance through realization of autonomous traveling that is extended and highly upgraded by combining and using 5G communication.

It is a further object of the present disclosure to provide an electronic device for vehicles capable of extending a user selection range by suggesting various routes and payment plans in consideration of an autonomous traveling function depending on traveling environment.

The objects of the present disclosure are not limited to the above-mentioned object, and other objects that have not been mentioned above will become evident to those skilled in the art from the following description.

### Technical Solution

In accordance with an aspect of the present disclosure, the above objects can be accomplished by the provision of an electronic device for vehicles, the electronic device including an interface and a processor configured to generate an autonomous traveling control signal based on sensor data sensed by a sensor mounted in a vehicle in a sensor autonomous traveling mode, to generate an autonomous traveling control signal based on the sensor data and traveling-related data received through communication with an external server in an integrated mode, and to switch between the sensor autonomous traveling mode and the integrated mode based on a user input signal received through the interface.

In accordance with another aspect of the present disclosure, there is provided an electronic device for vehicles of an autonomous vehicle controllable in a longitudinal direction and in a lateral direction by an external signal, the electronic device including an interface and a processor configured to generate an autonomous traveling control signal based on traveling-related data received through communication with an external server in a communication autonomous traveling mode, to generate an autonomous traveling control signal based on the traveling-related data and sensor data sensed by a sensor mounted in the vehicle in an integrated mode, and to switch between the communication autonomous traveling mode and the integrated mode based on a user input signal received through the interface.

The external server may be a server of a communication company system that supports a 5G-based autonomous traveling service, and the communication may use 5G communication.

In the integrated mode, the traveling-related data received through communication with the external server may be changed depending on a communication payment plan, and the communication payment plan may be set by user selection through the interface based on the result of calculation of a payment plan by route performed by the external server.

The payment plan by route may be obtained by the external server determining a possible autonomous traveling function of an ego vehicle, generating all routes to a destination, determining an autonomous traveling function required for each section on each route, comparing the possible autonomous traveling function of the ego vehicle with the autonomous traveling function required for each section to determine an autonomous traveling function that is additionally necessary by route, and calculating and the payment plan based on the autonomous traveling function that is additionally necessary.

In an embodiment of the present disclosure, an expressway-based autonomous traveling system may perform autonomous traveling in a downtown area using 5G communication.

In an embodiment of the present disclosure, an autonomous traveling system that is operated only on a clear day or during the day may perform autonomous traveling on a rainy day or at night using 5G communication.

In an embodiment of the present disclosure, a level-3 or level-4 autonomous vehicle may perform level-5 autonomous traveling on a level-5 dedicated road using 5G communication.

In an embodiment of the present disclosure, a level-2 autonomous vehicle having only a lane keeping function may receive multi-object tracking (MOT) information or lane information through 5G communication in order to change lanes or to use an exit/merge function on an expressway.

In an embodiment of the present disclosure, an autonomous vehicle capable of controlling only steering, acceleration, and deceleration may receive unmanned valet parking infrastructure information through 5G communication in order to use a unmanned valet parking function.

In an embodiment of the present disclosure, when a high-class payment plan for 5G communication is selected in the state in which a low-performance sensor is provided, it is possible to maintain an autonomous traveling level similar to when a basic payment plan is selected in the state in which a high-performance sensor is provided.

In an embodiment of the present disclosure, sensor diagnosis and on-line calibration are possible through a remote diagnosis module of a communication company system, autonomous traveling performance may be improved and autonomous traveling functions may be added through update of an autonomous traveling DNN, and a remote control service may be provided or accident prediction may be performed upon determining that an emergency occurs

The other details of the present disclosure are included in the following description and the accompanying drawings.

### Advantageous Effects

According to the present disclosure, one or more of the following effects are provided.

First, it is possible to provide a 5G communication-based autonomous traveling service to an autonomous vehicle through a communication unit that transmits and receives information using 5G communication and a communication company system that supports the 5G communication-based autonomous traveling service, whereby it is possible to improving the autonomous traveling level and to add an autonomous traveling function.

Second, it is possible to extend a recognizable area and to improve accuracy using only a sensor through a processor that switches from a sensor mode to a sensor-based integrated mode.

Third, it is possible to improve the autonomous traveling level of an autonomous vehicle, the possible function, performance, and stability of which are fixed depending on the autonomous traveling level thereof, through a processor that switches from a communication mode to a communication-based integrated mode.

Fourth, it is possible to improve traveling performance accordingly.

Fifth, it is possible to provide an autonomous traveling service graded depending on the payment plan, whereby it is possible to extend user selection and to use an economical and efficient autonomous traveling service.

It should be noted that effects of the present disclosure are not limited to the effects of the present disclosure as mentioned above, and other unmentioned effects of the present disclosure will be clearly understood by those skilled in the art from the following claims.

### DESCRIPTION OF DRAWINGS

FIG. 1 is a view showing the external appearance of a vehicle according to an embodiment of the present disclosure.

FIG. 2 is a control block diagram of the vehicle according to the embodiment of the present disclosure.

FIG. 3 is a block diagram of an autonomous traveling service system according to an embodiment of the present disclosure.

FIG. 4 is a basic block diagram of an autonomous vehicle system according to an embodiment of the present disclosure and an external server system.

FIG. 5 is a view showing a process of a processor generating an autonomous traveling control signal in a sensor autonomous traveling mode according to an embodiment of the present disclosure.

FIG. 6 is a view showing a process of the processor generating an autonomous traveling control signal using first data in an integrated mode according to an embodiment of the present disclosure.

FIG. 7 is a view showing a process of the processor generating an autonomous traveling control signal in a communication autonomous traveling mode according to an embodiment of the present disclosure.

FIG. 8 is a view showing a process of the processor generating an autonomous traveling control signal using second data in an integrated mode according to the embodiment of the present disclosure.

FIGS. 9 and 10 are views showing an autonomous traveling function required by route according to an embodiment of the present disclosure.

FIGS. 11a and 11b are views showing data and an autonomous traveling function provided to a vehicle by payment plan according to an embodiment of the present disclosure.

FIG. 12 is a block diagram showing a process of generating an autonomous traveling control signal by subject according to an embodiment of the present disclosure.

FIG. 13 is a block diagram showing a route and payment plan calculation method according to an embodiment of the present disclosure.

FIG. 14 is a block diagram showing an autonomous traveling function service provision method of a communication company system according to an embodiment of the present disclosure.

FIGS. 15a and 15b are views showing an additional autonomous traveling function or an auxiliary autonomous traveling function by payment plan.

FIGS. 16a and 16b are views showing a process of determining whether lane change is necessary and possible by subject according to an embodiment of the present disclosure.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

It will be understood that, although the terms “first,” “second,” etc., may be used herein to describe various components, these components should not be limited by these terms. These terms are only used to distinguish one component from another component.

It will be understood that, when a component is referred to as being “connected to” or “coupled to” another component, it may be directly connected to or coupled to another component or intervening components may be present.

As used herein, the singular form is intended to include the plural forms as well, unless the context clearly indicates otherwise.

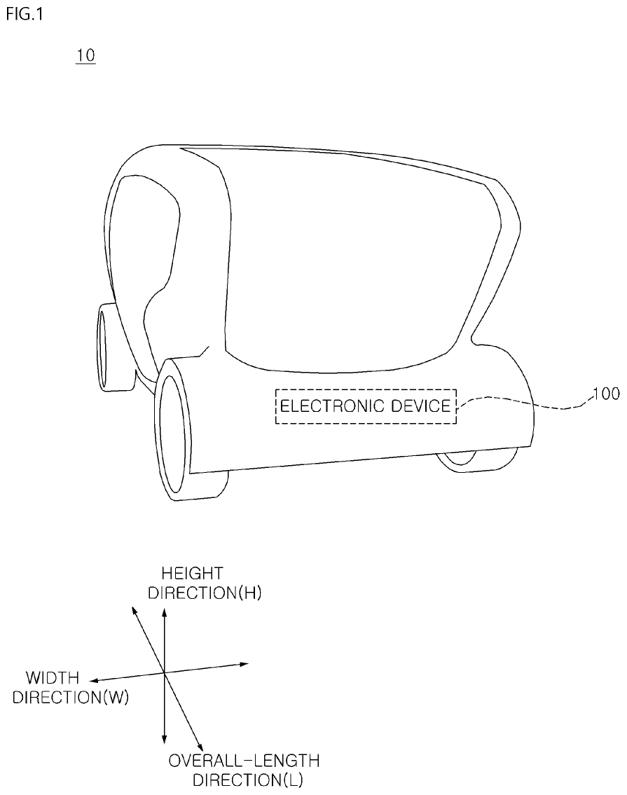

FIG. 1 is a view showing the external appearance of a vehicle 10 according to an embodiment of the present disclosure.

Referring to FIG. 1, the vehicle 10 according to the embodiment of the present disclosure is defined as a transport means that runs on a road or a railway. The vehicle 10 may be a concept including a car, a train, and a motorcycle, and may be a concept including all of an internal combustion engine vehicle including an engine as a power source, a hybrid vehicle including both an engine and an electric motor as a power source, an electric vehicle including an electric motor as a power source, and other vehicles including power sources other than the above-mentioned power sources. The vehicle 10 may be a shared vehicle or an autonomous vehicle.

The vehicle 10 may include an electronic device 100 for vehicles, and the electronic device 100 for vehicles may be a device that provides an autonomous traveling function, a description of which will follow, or generates an autonomous traveling control signal according to an autonomous traveling function that is additionally necessary for the vehicle 10 to autonomously travel.

The vehicle 10 may switch between an autonomous traveling mode and a manual mode based on user input. For example, the vehicle 10 may switch from the manual mode to the autonomous traveling mode or from the autonomous traveling mode to the manual mode based on user input received through a user interface device 200.

The vehicle 10 may switch to the autonomous traveling mode or to the manual mode based on traveling status information. The traveling status information may include at least one of object information outside the vehicle, navigation information, or vehicle state information.

For example, the vehicle 10 may switch from the manual mode to the autonomous traveling mode or from the autonomous traveling mode to the manual mode based on traveling status information generated by an object detection device 210, and may switch from the manual mode to the autonomous traveling mode or from the autonomous traveling mode to the manual mode based on traveling status information received through a communication device 220. In addition, the vehicle may switch from the manual mode to the autonomous traveling mode or from the autonomous traveling mode to the manual mode based on information, data, or a signal provided by an external device.

In the case in which the vehicle 10 is operated in the autonomous traveling mode, the autonomous vehicle 10 may be operated based on an operation system 260. In the case in which the vehicle 10 is operated in the manual mode, the autonomous vehicle 10 may receive user input for driving through a driving manipulation device 230. The vehicle 10 may be operated based on user input received through the driving manipulation device 230.

“Overall length” means the length from the front end to the rear end of the vehicle 10, “width” means the width of the vehicle 10, and “height” means the length from the lower end of each wheel to a roof of the vehicle 10. In the following description, “overall-length direction L” may mean a direction based on which the overall length of the vehicle 10 is measured, “width direction W” may mean a direction based on which the width of the vehicle 10 is measured, and “height direction H” may mean a direction based on which the height of the vehicle 10 is measured.

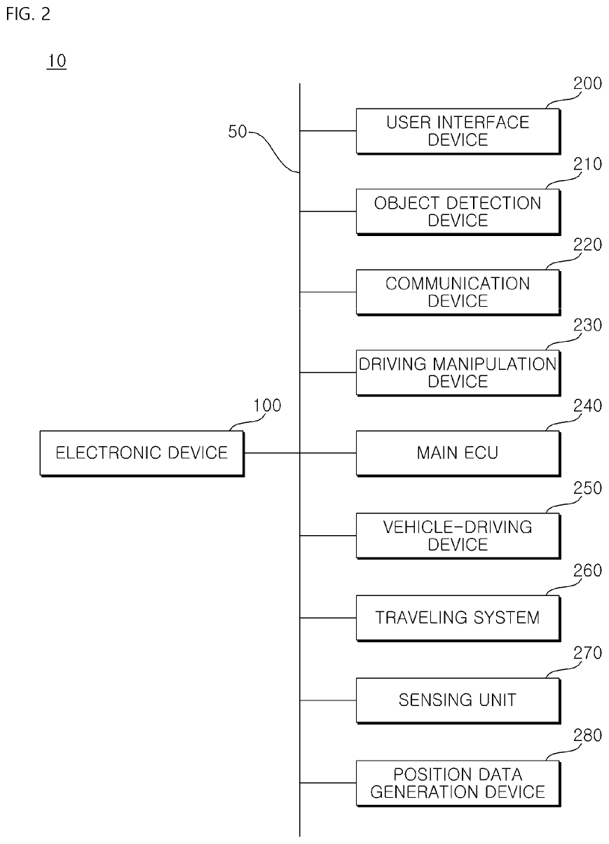

FIG. 2 is a control block diagram of the vehicle 10 according to the embodiment of the present disclosure.

Referring to FIG. 2, the vehicle 10 may include an electronic device 100 for vehicles, a user interface device 200, an object detection device 210, a communication device 220, a driving manipulation device 230, a main ECU 240, a vehicle driving device 250, a traveling system 260, a sensing unit 270, and a position data generation device 280.

The electronic device 100 for vehicles may be an electronic device that exchanges data with at least one external server to receive an autonomous traveling function from the external server and to generate an autonomous traveling control signal. In this case, the communication device 220 may be used. The server 300 may be a communication company system that supports an autonomous traveling function based on 5G communication.

The user interface device 200, which is a device for communication between the vehicle 10 and the user, may receive user input, and may provide information generated by the vehicle to the user. The vehicle 10 may realize a user interface (UI) or a user experience (UX) through the user interface device 200.

The object detection device 210, which is a device capable of detecting an object outside the vehicle 10, may include at least one detection means selected from among a camera, a radar, a lidar, an ultrasonic sensor, and an infrared sensor, and may provide data about an object generated based on a signal generated by the detection means to at least one electronic device included in the vehicle.

The communication device 220, which is a device capable of exchanging a signal with a device located outside the vehicle 10, may exchange a signal with at least one of infrastructure, such as a server or a broadcasting station, or another vehicle, and may include at least one of a transmission antenna, a reception antenna, a radio frequency (RF) circuit capable of realizing various communication protocols, or an RF element in order to perform communication.

The communication device 220 may include a vehicle to everything (V2X) communication unit. The V2X communication unit, which is a unit for wireless communication with a server (V2I: Vehicle to Infrastructure), another vehicle (V2V: Vehicle to Vehicle), or a pedestrian (V2P: Vehicle to Pedestrian) or for wired or wireless in-vehicle networking (IVN), may include an RF circuit capable of realizing protocols for communication with infrastructure (V2I), communication between vehicles (V2V), communication with a pedestrian (V2P), and in-vehicle networking (IVN).

The communication device 220 may transmit and receive information to and from the external server 300 using 5G communication. 5G communication is a mobile communication service that has a maximum speed of up to 20 Gbps, which is about 20 times as fast as the maximum speed (1 Gbps) of LTE, which is the previous generation, and that has processing capacity 100 times as large thereas. Consequently, 5G communication has the advantage of ultra-low latency (a latency of 1 ms) and ultra-connectivity, based on which virtual reality (VR), autonomous traveling, Internet of Things (IoT), etc. may be realized.

The communication device 220 may transmit information sensed by the sensing unit 270 to the external server 300 through 5G communication. The information sensed by the sensing unit 270 may include surrounding object information or surrounding environment information detected by the detection means, such as the camera, the radar, the lidar, the ultrasonic sensor, and the infrared sensor. In addition, vehicle information, such as vehicle state information obtainable through IVN and vehicle position information obtainable through GPS, may be transmitted together, and information sensed by the sensing unit 270 may include non-processed sensing information.

The driving manipulation device 230 is a device that receives user input for driving. In a manual mode, the vehicle 10 may be operated based on a signal provided by the driving manipulation device 230. The driving manipulation device may include a steering input device, such as a steering wheel, an acceleration input device, such as an accelerator pedal, and a brake input device, such as a brake pedal.

The main ECU 240 may control the overall operation of the at least one electronic device included in the vehicle 10.

The vehicle driving device 250, which is a device that electrically controls various devices in the vehicle 10, may include a powertrain driving unit, a chassis driving unit, a door/window driving unit, a safety apparatus driving unit, a lamp driving unit, and an air conditioner driving unit. The powertrain driving unit may include a power source driving unit and a gearbox driving unit, and the chassis driving unit may include a steering driving unit, a brake driving unit, and a suspension driving unit. The safety apparatus driving control device may include a safety belt driving unit for controlling a safety belt.

The traveling system 260 may control the movement of the vehicle 10, or may generate a signal for outputting information to the user, based on data about an object received by the object detection device 210, and may provide the generated signal to at least one of the user interface device 200, the main ECU 240, or the vehicle driving device 250.

The traveling system 260 may be a concept including an ADAS, and the ADAS may realize at least one of an adaptive cruise control (ACC) system, an autonomous emergency braking (AEB) system, a forward collision warning (FCW) system, a lane keeping assist system (LKAS), a lane change assist (LCA) system, a target following assist (TFA) system, a blind spot detection (BSD) system, an adaptive high beam assist (HBA) system, an auto parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous device (e.g. an autonomous electronic control unit (ECU)), and may set an autonomous traveling route based on data received from at least one of other electronic devices in the vehicle 10. In addition, the traveling system may set the autonomous traveling route based on data received from at least one of the user interface device 200, the object detection device 210, the communication device 220, the sensing unit 270, or the position data generation device 280, and may generate a control signal such that the vehicle 10 travels along the set autonomous traveling route.

The sensing unit 270 may include at least one of an inertial measurement unit (IMU) sensor, a collision sensor, a wheel sensor, a speed sensor, a slope sensor, a weight sensor, a heading sensor, a position module, a vehicle forward/rearward movement sensor, a battery sensor, a fuel sensor, a tire sensor, a steering wheel rotation sensor, an in-vehicle temperature sensor, an in-vehicle humidity sensor, an ultrasonic sensor, an ambient light sensor, an accelerator pedal position sensor, or a brake pedal position sensor. The inertial measurement unit (IMU) sensor may include one or more of an acceleration sensor, a gyro sensor, and a magnetic sensor.

The sensing unit 270 may generate vehicle state data based on a signal generated by at least one sensor. The sensing unit 270 may generate vehicle orientation information, vehicle motion information, vehicle yaw information, vehicle roll information, vehicle pitch information, vehicle collision information, vehicle direction information, vehicle angle information, vehicle speed information, vehicle acceleration information, vehicle tilt information, vehicle forward/rearward movement information, battery information, fuel information, tire information, vehicle lamp information, in-vehicle temperature information, in-vehicle humidity information, and a sensing signal, such as a steering wheel rotation angle, ambient light outside the vehicle, pressure applied to an accelerator pedal, and pressure applied to a brake pedal.

In addition, the sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and a safety belt tension sensor.

The vehicle state information may be information generated based on data sensed by various sensors provided in the vehicle. For example, the vehicle state information may include vehicle orientation information, vehicle speed information, vehicle tilt information, vehicle weight information, vehicle direction information, vehicle battery information, vehicle fuel information, information about the air pressure of tires of the vehicle, vehicle steering information, in-vehicle temperature information, in-vehicle humidity information, pedal position information, and vehicle engine temperature information.

The position data generation device 280 may include at least one of a global positioning system (GPS) or a differential global positioning system (DGPS), and may generate position data of the vehicle 10 based on a signal generated by at least one of the GPS or the DGPS. In some embodiments, the position data generation device 280 may correct position data based on at least one of an inertia measurement unit (IMU) of the sensing unit 270 or the camera of the object detection device 210.

The vehicle 10 may include an internal communication system 50, and a plurality of electronic devices included in the vehicle 10 may exchange a signal with each other via the internal communication system 50. The signal may include data. The internal communication system 50 may use at least one communication protocol, such as CAN, LIN, FlexRay, MOST, or Ethernet.

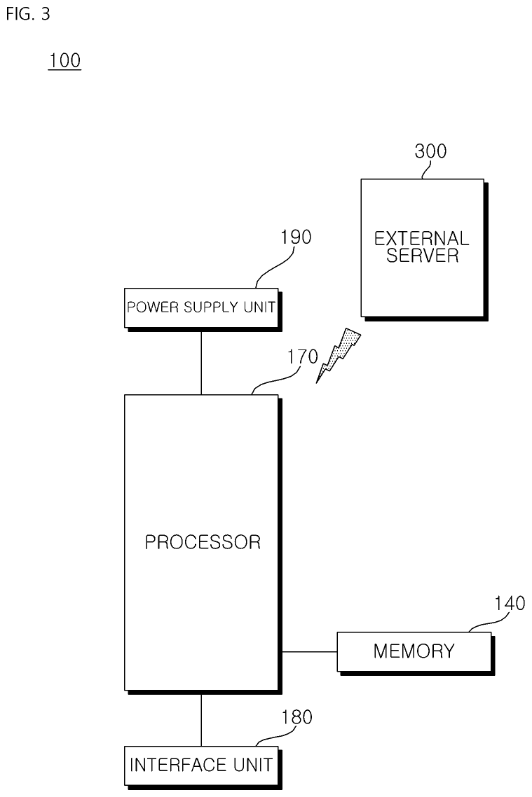

FIG. 3 is a block diagram of an electronic device 100 for vehicles according to an embodiment of the present disclosure.

Referring to FIG. 3, the electronic device 100 for vehicles may include a memory 140, a processor 170, an interface 180, and a power supply unit 190. In addition, the electronic device may exchange data with at least one external server 300 through the communication device 220. The external server 300 may be a server of a communication company system that supports an autonomous traveling service based on 5G communication.

The memory 140 may be electrically connected to the processor 170, may store basic data about the units, control data necessary to control the operation of the units, and data that are input and output, and may store data processed by the processor 170. The memory 140 may be constituted by at least one of a ROM, a RAM, an EPROM, a flash drive, or a hard drive, and may store various data necessary to perform the overall operation of the electronic device, such as a program for processing or control of the processor 170. The memory 140 may be integrated into the processor 170. In some embodiments, the memory may be classified as a low-level component of the processor 170.

The interface 180 may exchange a signal with at least one of the user interface device 200, the object detection device 210, the communication device 220, the driving manipulation device 230, the main ECU 240, the vehicle driving device 250, the ADAS 260, the sensing unit 270, or the position data generation device 280 in a wired or wireless fashion, and may be constituted by at least one of a communication module, a terminal, a pin, a cable, a port, a circuit, an element, or a device.

The processor 170 may receive a user input signal through the interface 180, and may receive sensor data sensed by the sensing unit 270 and traveling-related data generated by the external server 300.

The power supply unit 190 may receive power from a power source (e.g. a battery) included in the vehicle 10, and may supply the received power to the respective units of the electronic device.

The processor 170 may be electrically connected to the memory 140, the interface 180, and the power supply unit 190 in order to exchange a signal therewith, and may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

In the state of receiving power provided by the power supply unit 190, the processor 170 may receive data, may process the data, may generate a signal, and may provide the signal, and may receive information from another electronic device in the vehicle 10, or may transmit a control signal to the other electronic device in the vehicle 10, through the interface 180.

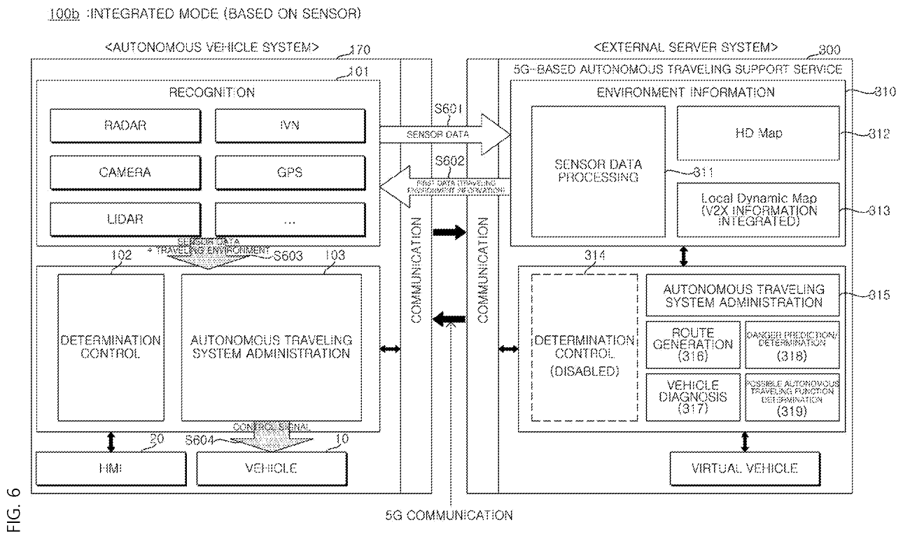

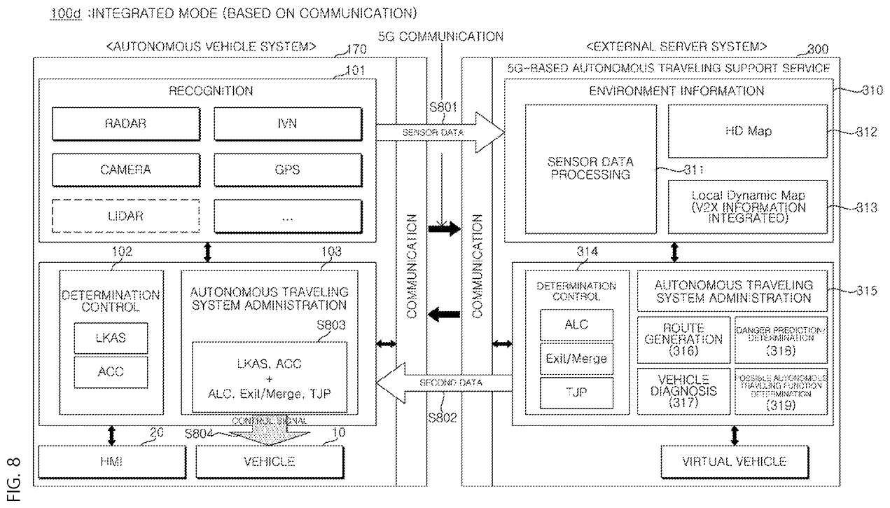

The processor 170 may exchange information with the external server 300 through the communication device 220. The information that the processor exchanges with the external server 300 may be changed depending on a mode. The mode may be divided into a sensor autonomous traveling mode 100a, shown in FIG. 6, and a communication autonomous traveling mode 100c and an integrated mode, shown in FIG. 8.

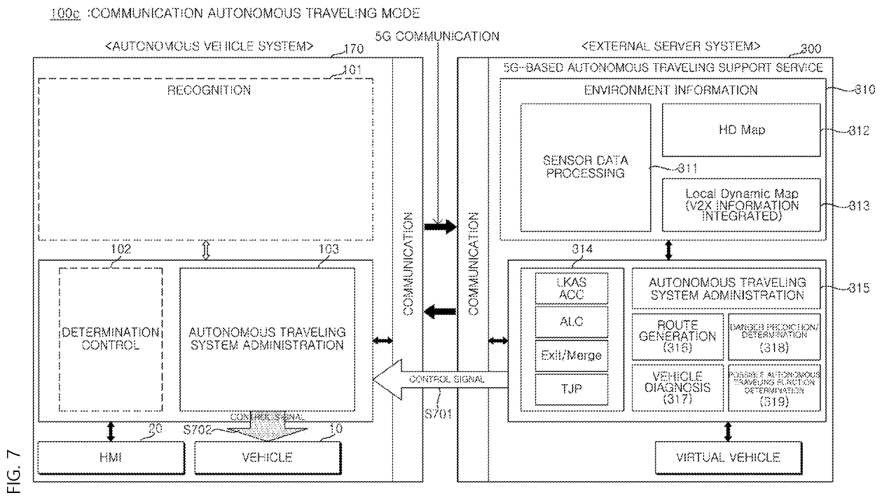

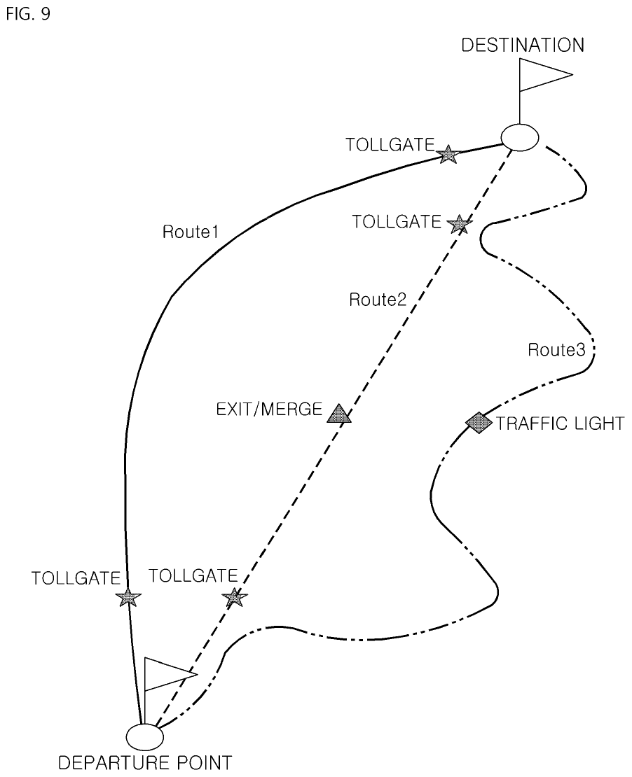

The integrated mode may be divided into a sensor-based integrated mode 100b, shown in FIG. 7, and a communication-based integrated mode 100d, shown in FIG. 9.

The sensor-based integrated mode 100b may be an integrated mode when a high-performance sensor is mounted in the vehicle 10. In the case in which the level of a possible autonomous traveling function of an ego vehicle based on data sensed by the sensor mounted in the vehicle 10 is high and thus traveling performance is high, the vehicle may travel in the sensor-based integrated mode 100b for autonomous traveling.

For example, in the case in which the possible autonomous traveling function of the ego vehicle includes LKA (Lane Keeping Assist), ACC (Adaptive Cruise Control), TJP (Traffic Jam Pilot), LCA (Lane Change Assist), and Exit/Merge, traveling performance is high, and therefore the vehicle may travel in the sensor-based integrated mode 100b for autonomous traveling.

The communication-based integrated mode 100d may be an integrated mode when no high-performance sensor is mounted in the vehicle 10. In the case in which the level of the possible autonomous traveling function of the ego vehicle based on data sensed by the sensor mounted in the vehicle 10 is not high and thus traveling performance is low, the vehicle may travel in the communication-based integrated mode 100d for autonomous traveling.

For example, in the case in which the possible autonomous traveling function of the ego vehicle includes LKA (Lane Keeping Assist) and ACC (Adaptive Cruise Control), traveling performance is low, and therefore the vehicle may travel in the communication-based integrated mode 100d for autonomous traveling.

Traveling performance may be determined based on required time or distance to a destination, traveling stability based on expected number of driver interventions (e.g. Exit/Merge or tollgates), and autonomous traveling function failure statistics.

The processor 170 may switch from the sensor autonomous traveling mode 100a to the integrated mode 100b or from the communication autonomous traveling mode 100c to the integrated mode 100d based on user input. For example, the processor 170 may switch from the sensor autonomous traveling mode 100a to the integrated mode 100b or from the communication autonomous traveling mode 100c to the integrated mode 100d based on user input received through the user interface device 200.

The processor 170 may switch from the integrated mode 100b to the sensor autonomous traveling mode 100a or from the integrated mode 100d to the communication autonomous traveling mode 100c based on user input.

In the sensor autonomous traveling mode 100a, the processor 170 may generate an autonomous traveling control signal based on sensor data sensed by the sensor mounted in the vehicle 10.

In the communication autonomous traveling mode 100c, the processor 170 may generate an autonomous traveling control signal based on traveling-related data received through communication with the external server 300.

In the integrated modes 100b and 100d, the processor 170 may generate an autonomous traveling control signal based on traveling-related data received through communication with the external server 30 and sensor data sensed by the sensor mounted in the vehicle.

The processor 170 may determine the possible autonomous traveling function of the ego vehicle, and may generate an autonomous traveling control signal based on the possible autonomous traveling function of the ego vehicle. The possible autonomous traveling function is determined based on at least one of the construction of the sensor mounted in the ego vehicle, the construction of an autonomous traveling algorithm, road environment, or weather environment, and the autonomous traveling function, such as LKA (Lane Keeping Assist), ACC (Adaptive Cruise Control), TJP (Traffic Jam Pilot), LCA (Lane Change Assist), and Exit/Merge, is determined.

The construction of the sensor mounted in the ego vehicle may be determined through the kind of a sensor, such as a camera, a radar, a lidar, or a GPS, the position at which the sensor is mounted, and sensor performance, such as field of view (FOV), measurement distance, and sampling rate. The construction of the autonomous traveling algorithm may be determined through the function and performance of the algorithm, the road environment may be determined based on traffic, the radius of curvature, whether the road is an expressway or a downtown, and the weather environment may be determined based on whether it snows or rains and a time zone.

The processor 170 may receive at least one of information about traveling environment, positioning information, autonomous traveling function information, or autonomous traveling control command information from the external server 300 based on user selection of a payment plan.

In the selection of the payment plan, the external server 300 may determine the possible autonomous traveling function (S441), may generate all routes to a destination (S442), may determine an autonomous traveling function required for each section on each route (S443), may compare the possible autonomous traveling function of the ego vehicle with the autonomous traveling function required for each section (S444) to determine an autonomous traveling function that is additionally necessary by route, and may calculate the payment plan based on the autonomous traveling function that is additionally necessary, and the user may select the payment plan.

In the sensor-based integrated mode 100b, the processor 170 may determine an auxiliary autonomous traveling function that assists the possible autonomous traveling function of the ego vehicle based on the traveling-related data according to the payment plan and sensor data sensed by the sensor, and may control autonomous traveling of the ego vehicle based further on the auxiliary autonomous traveling function.

The processor 170 may provide an auxiliary autonomous traveling function that assists the possible autonomous traveling function of the ego vehicle at an auxiliary level through the sensor-based integrated mode 100b. The auxiliary autonomous traveling function that can be added may be changed depending on the payment plan.

In the communication-based integrated mode 100d, the processor 170 may generate an autonomous traveling control signal having secured redundancy in consideration of an external autonomous traveling control signal and the possible autonomous traveling function of the ego vehicle that can be obtained through the sensor, and may control autonomous traveling of the ego vehicle.

In addition, the processor may determine an additional autonomous traveling function that is additionally necessary for autonomous traveling to the selected route, and may control autonomous traveling of the ego vehicle based further on the additional autonomous traveling function. The additional autonomous traveling function that can be added may be changed depending on the payment plan.

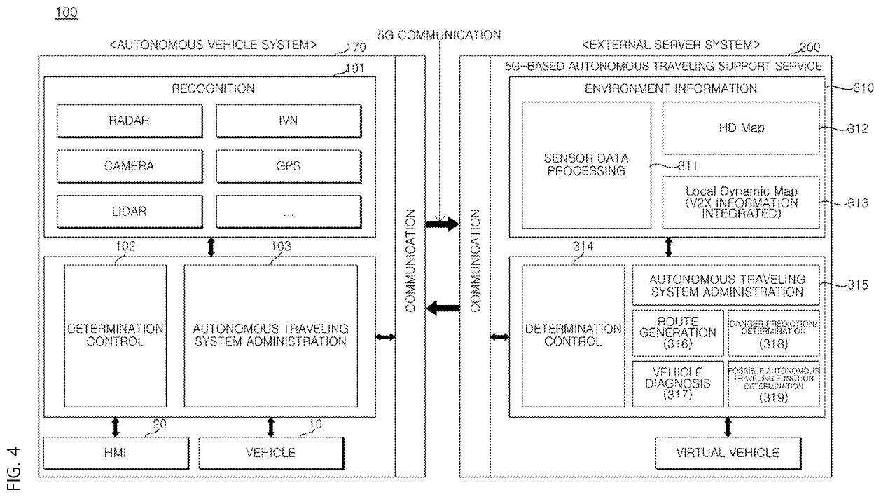

FIG. 4 is a basic block diagram of an autonomous vehicle system according to an embodiment of the present disclosure and an external server system.

Referring to FIG. 4, the electronic device 100 for vehicles may be driven by the autonomous vehicle system and the external server 300 system. The autonomous vehicle system may exchange a signal, information, or data through a communication network, and may control autonomous traveling of the vehicle 10 using a recognition algorithm and a determination/control algorithm. The autonomous vehicle system and the external server 300 system may exchange data with each other through 5G communication.

The autonomous vehicle system may include a recognition module 101, a determination/control module 102, and an autonomous traveling system administration module 103, and each module may be operated according to an algorithm. For example, the recognition module 101 may be operated according to the recognition algorithm.

The recognition algorithm may be a procedure or method of collecting vehicle information, such as surrounding object information or surrounding environment information detected by the detection means, such as the camera, the radar, or the lidar, vehicle state information obtainable through IVN, and vehicle position information obtainable through GPS.

The determination/control algorithm may be a procedure or method of determining and controlling the autonomous traveling function, such as LKA (Lane Keeping Assist), ACC (Adaptive Cruise Control), TJP (Traffic Jam Pilot), LCA (Lane Change Assist), and Exit/Merge, based on the information collected through the recognition algorithm.

The external server 300 system may include an environment information module 310, such as a sensor data processing module 311, an HD map module 312, and a local dynamic map module 313, and an autonomous traveling system administration module 315, such as a route generation module 316, a vehicle diagnosis module 317, a danger prediction/determination module 318, and a possible autonomous traveling function determination module 319. The external server 300 system may further include a determination/control module 314.

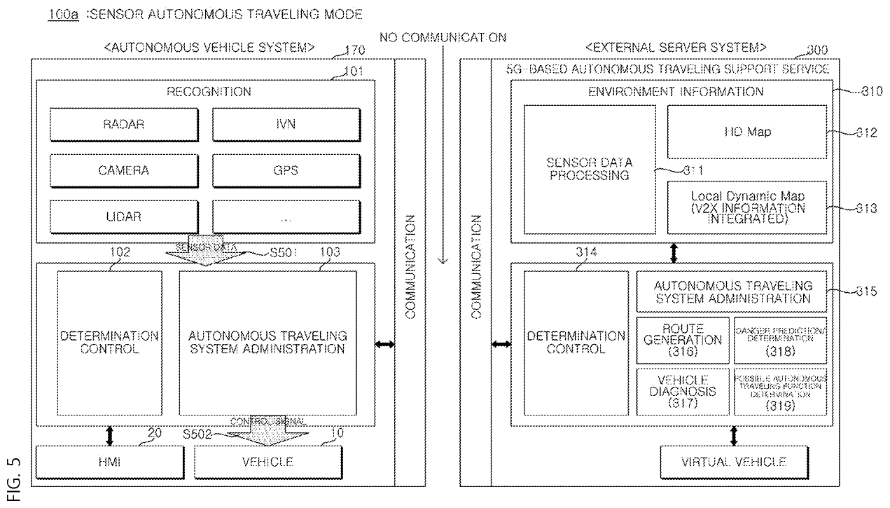

FIG. 5 is a view showing a process (S502) of the processor generating an autonomous traveling control signal in a sensor autonomous traveling mode 100a according to an embodiment of the present disclosure.

Referring to FIG. 5, in the sensor autonomous traveling mode 100a, the processor 170 may receive sensor data through the interface 180, and may generate an autonomous traveling control signal of the vehicle 10 based on the sensor data. The processor 170 may determine a possible autonomous traveling function of the ego vehicle, and may generate an autonomous traveling control signal based on the possible autonomous traveling function of the ego vehicle.

In the sensor autonomous traveling mode 100a, communication may not be connected.

In the sensor autonomous traveling mode 100a, the processor 170 may generate an autonomous traveling control signal of the vehicle 10 through a step of generating sensor data (S501) and a step of generating an autonomous traveling control signal (S502).

The sensor data may be information sensed by the sensor, including surrounding object information or surrounding environment information detected by the detection means, such as the camera, the radar, or the lidar, vehicle state information obtainable through IVN, and vehicle position information obtainable through GPS. The autonomous traveling control signal may be generated through the determination/control module 102 and the autonomous traveling system administration module 103.

FIG. 6 is a view showing a process (S604) of the processor generating an autonomous traveling control signal using first data (S602) in an integrated mode 100b according to an embodiment of the present disclosure.

Referring to FIG. 6, in the sensor-based integrated mode 100b, the processor 170 may exchange information with the external server 300 through 5G communication in order to generate an autonomous traveling control signal of the vehicle 10.

In the sensor-based integrated mode 100b, the processor 170 may generate an autonomous traveling control signal based on sensor data and traveling-related data received through communication with the external server.

The traveling-related data received through communication with the external server 300 may be generated by the external server 300 receiving sensor data from the processor 170 and comparing a possible autonomous traveling function of the ego vehicle based on the sensor data with an autonomous traveling function required for each section.

In the case in which the external server 300 determines that the autonomous traveling function required for each section is not higher than the possible autonomous traveling function of the ego vehicle, the traveling-related data may be first data, which are data for providing an auxiliary autonomous traveling function that assists the possible autonomous traveling function of the ego vehicle.

The first data may be generated through at least one of the sensor data processing module 311, the HD map module 312, or the local dynamic map module 313 of the environment information module 310 and the autonomous traveling system administration module 315 of the external server.

The processor 170 may determine a possible autonomous traveling function of the ego vehicle and an auxiliary autonomous traveling function based on the sensor data and the first data, and may generate an autonomous traveling control signal based on the possible autonomous traveling function of the ego vehicle and the auxiliary autonomous traveling function.

In the integrated modes 100b and 100d, the traveling-related data received through communication with the external server 300 may be changed depending on a communication payment plan, and the communication payment plan may be based on the result of calculation of the payment plan by route performed by the external server 300. In addition, the communication payment plan may be set by user selection through the interface 180.

In the case in which the communication payment plan is set to a basic payment plan, the traveling-related information may be traveling environment information that is at least one of the HD map information or local dynamic map information generated by the external server 300 based on sensor data received from the processor 170.

The processor 170 may determine an auxiliary autonomous traveling function that assists the possible autonomous traveling function of the ego vehicle based on information about traveling environment depending on the payment plan and information sensed by the sensor, and may control autonomous traveling of the vehicle 10 based further on the auxiliary autonomous traveling function.

In the sensor-based integrated mode 100b, the vehicle 10 may be controlled through a step of transmitting sensor data to the external server 300 (S601), a step of receiving first data or traveling environment information from the external server 300 (S602), a step of determining an autonomous traveling function based on the sensor data and the traveling environment information (S603), and a step of generating an autonomous traveling control signal (S604).

The sensor data may be information sensed by the sensor, including surrounding object information or surrounding environment information detected by the detection means, such as the camera, the radar, or the lidar, vehicle state information obtainable through IVN, and vehicle position information obtainable through GPS. An autonomous traveling control command may be generated through the determination/control module 102 and the autonomous traveling system administration module 103.

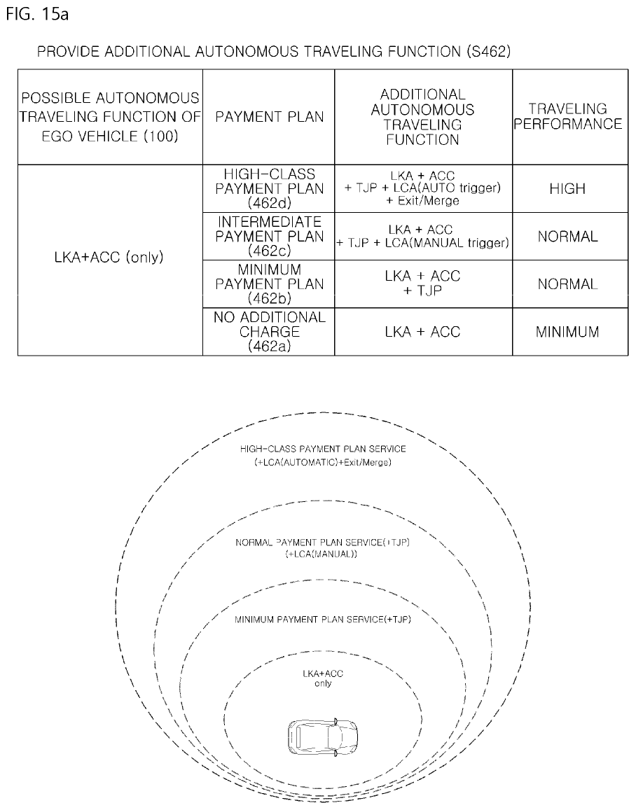

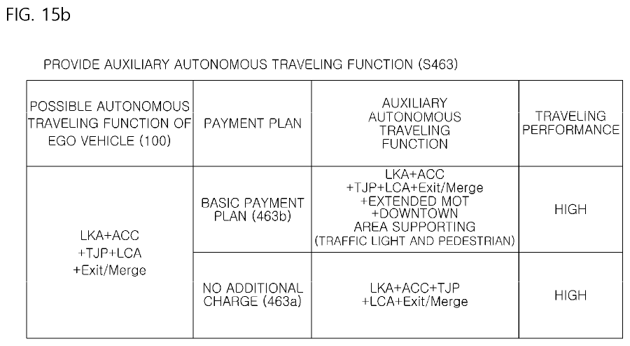

Referring to FIG. 15b, in the case in which the possible autonomous traveling function of the ego vehicle includes LKA, ACC, TJP, LCA, and Exit/Merge, i.e. the level thereof is high, it is possible to receive an extended multi-object tracking (MOT) function or a downtown area supporting function (traffic light and pedestrian information), which is an auxiliary autonomous traveling function that assists the possible autonomous traveling function of the ego vehicle, through 5G communication merely using the basic payment plan.

FIG. 7 is a view showing a process (S702) of the processor generating an autonomous traveling control signal in a communication autonomous traveling mode 100c according to an embodiment of the present disclosure.

Referring to FIG. 7, in the communication autonomous traveling mode 100c, the processor 170 may generate an autonomous traveling control signal based on traveling-related data received through communication with the external server 300.

The traveling-related data received through communication with the external server 300 may be external signal data capable of controlling autonomous traveling of the vehicle 10, which are generated through the environment information module 310, the autonomous traveling system administration module 315, and the determination/control module 314 of the external server 300.

The processor 10 may receive the external signal data in order to generate an autonomous traveling control signal even without operation of the sensor mounted in the vehicle.

In the communication autonomous traveling mode 100c, the processor 170 may receive an autonomous traveling function provided by the external server 300 or an external autonomous traveling control signal through 5G communication, and may control the vehicle 10 based on the autonomous traveling function or the external autonomous traveling control signal.

In the communication autonomous traveling mode 100c, the vehicle 10 may be controlled through a step of receiving an external autonomous traveling control signal generated by the external server 300 (S701) and a step of generating an autonomous traveling control signal (S702).

FIG. 8 is a view showing a process (S804) of the processor generating an autonomous traveling control signal using second data (S802) in an integrated mode 100d according to the embodiment of the present disclosure.

Referring to FIG. 8, in the communication-based integrated mode 100d, the processor 170 may exchange information with the external server 300 through 5G communication in order to generate an autonomous traveling control signal of the vehicle 10.

In the communication-based integrated mode 100d, the processor 170 may generate an autonomous traveling control signal based on sensor data sensed by the sensor mounted in the vehicle and traveling-related data received through communication with the external server.

The traveling-related data received through communication with the external server 300 may be generated by the external server 300 receiving sensor data from the processor 170 and comparing a possible autonomous traveling function of the ego vehicle based on the sensor data with an autonomous traveling function required for each section. The sensor data may be non-processed sensor data.

In the case in which the external server 300 determines that the autonomous traveling function required for each section is higher than the possible autonomous traveling function of the ego vehicle, the traveling-related data may be second data, which are data for providing an additional autonomous traveling function that is added to the possible autonomous traveling function of the ego vehicle and external signal data capable of controlling autonomous traveling of the vehicle, which are generated based thereon.

The second data may be generated through at least one of the sensor data processing module 311, the HD map module 312, or the local dynamic map module 313 of the environment information module 310, and the autonomous traveling system administration module 315, and the determination/control module 314 of the external server 300.

The processor 170 may determine a possible autonomous traveling function of the ego vehicle and an additional autonomous traveling function based on the sensor data and the second data, and may generate an autonomous traveling control signal based on the possible autonomous traveling function of the ego vehicle and the additional autonomous traveling function.

In the integrated modes 100b and 100d, the traveling-related data received through communication with the external server 300 may be changed depending on a communication payment plan, and the communication payment plan may be based on the result of calculation of the payment plan by route performed by the external server 300. In addition, the communication payment plan may be set by user selection through the interface 180.

Data provided from the external server 300 to the vehicle are changed depending on the payment plan, and the data provided from the external server 300 to the vehicle 10 include at least one of positioning information, information related to traveling environment, autonomous traveling function information, or autonomous traveling control command information

In the communication-based integrated mode 100b, the vehicle 10 may be controlled through a step of transmitting sensor data to the external server 300 (S801), a step of receiving second data including an external autonomous traveling control signal from the external server 300 (S802), a step of determining a possible autonomous traveling function of the ego vehicle and an additional autonomous traveling function (S803), and a step of generating an autonomous traveling control signal (S804).

The sensor data may be processed by at least one of the sensor data processing module 311, the HD map module 312, or the local dynamic map module 313 of the environment information module 310 of the external server 300. The processed environment information may be used to determine an additional autonomous traveling function that is additionally needed by the determination/control module 314 and the autonomous traveling system administration module 315, and an external autonomous traveling control signal may be generated based on the additional autonomous traveling function.

The processor 170 may generate an autonomous traveling control signal having secured redundancy based on determination of the possible autonomous traveling function of the ego vehicle and the additional autonomous traveling function and the external autonomous traveling control signal in order to control the vehicle 10, and traveling performance may be improved by securing the additional autonomous traveling function.

For example, referring to FIG. 15a, in the case in which the possible autonomous traveling function of the ego vehicle includes LKA and ACC and the additional autonomous traveling function includes TJP, LCA, and Exit/Merge, the possible autonomous traveling function determination module 319 of the external server 300 may determine that the possible autonomous traveling function of the ego vehicle includes LKA and ACC, and the determination/control module 314 may determine that the additional autonomous traveling function includes TJP, LCA, and Exit/Merge. In conclusion, the vehicle 10 may be controlled based on the autonomous traveling function, such as LKA, ACC, TJP, LCA, and Exit/Merge.

Redundancy is defined as follows. In the case in which any one of the electronic devices included in the autonomous vehicle 10 fails, autonomous traveling is not smoothly performed, whereby there is a high possibility of occurrence of an accident. In order to solve this problem, an autonomous traveling service is provided through a communication network (e.g. a 5G communication network) in addition to traveling based on the algorithm of the vehicle 10 in order to realize a safer system, which is redundancy.

In the communication-based integrated mode 100d, the vehicle 10 may autonomously travel according to the algorithm thereof. In the case in which the electronic devices included in the vehicle 10 fail, however, autonomous traveling may be performed based on the result values of recognition, determination, and control generated by the communication company system that supports autonomous traveling, whereby autonomous traveling having secured redundancy may be possible.

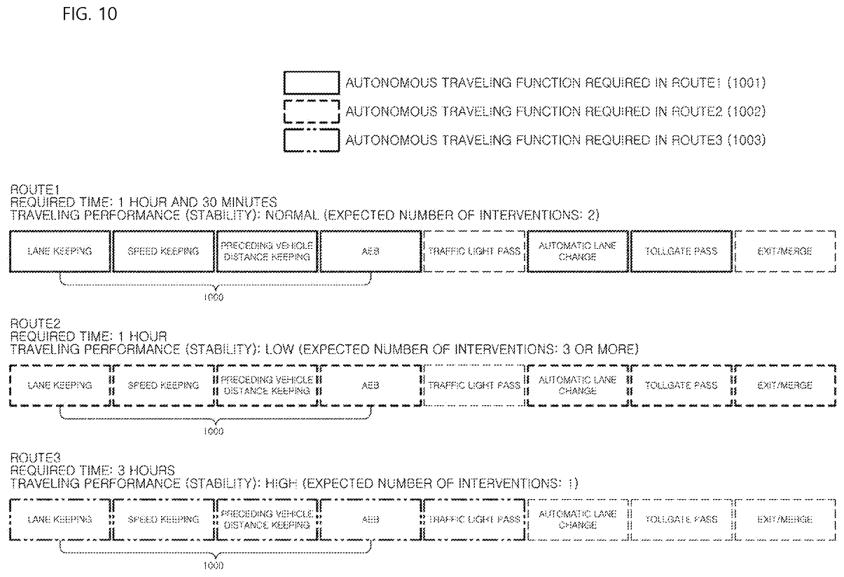

FIGS. 9 and 10 are views showing an autonomous traveling function required by route according to an embodiment of the present disclosure.

FIG. 9 is a view showing all routes to a destination.

Route1 may be a route in which 1 hour and 30 minutes are needed to reach a destination, the vehicle passes through tollgates, the expected number of driver interventions is 2, and traveling performance (stability) is normal.

Route2 may be a route in which 1 hour is needed to reach the destination, the vehicle passes through tollgates and an exit/merge point, the expected number of driver interventions is 3, and traveling performance (stability) is low.

Route3 may be a route in which 3 hours are needed to reach the destination, the vehicle passes through a traffic light, the expected number of driver interventions is 1, and traveling performance (stability) is high.

FIG. 10 is a view showing a possible autonomous traveling function 1000 of the ego vehicle and autonomous traveling functions 1001, 1002, and 1003 required in traveling environments based on the respective routes.

In the case in which the possible autonomous traveling function 1110 of the ego vehicle includes a lane keeping function, a speed keeping function, a preceding vehicle distance keeping function, and AEB, the autonomous traveling functions required in traveling environments based on the respective routes Route1, Route2, and Route3 and an additional autonomous traveling function supported in each payment plan may be changed.

The autonomous traveling function 1001 required in Route1 may include an automatic lane change function and a tollgate pass function, in addition to the lane keeping function, the speed keeping function, the preceding vehicle distance keeping function, and the AEB, which are included in the possible autonomous traveling function 1000 of the ego vehicle, since the vehicle must pass through the tollgates.

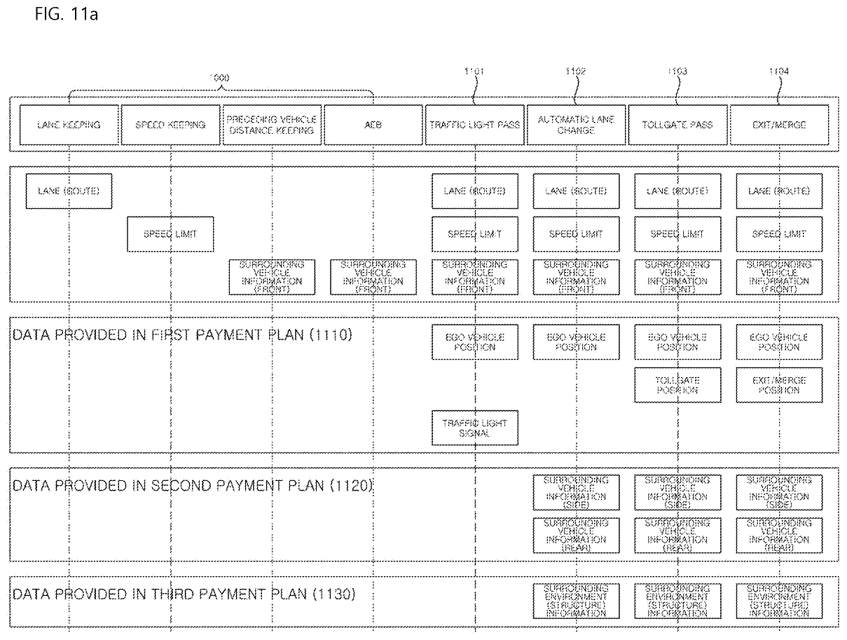

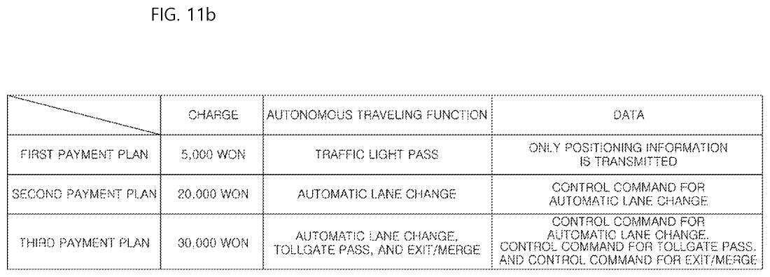

Referring to FIG. 11a, a second payment plan may support the automatic lane change function 1102, and a third payment plan may support the tollgate pass function 1103.

The autonomous traveling function 1002 required in Route2 may include the automatic lane change function, the tollgate pass function, and an exit/merge function, in addition to the lane keeping function, the speed keeping function, the preceding vehicle distance keeping function, and the AEB, which are included in the possible autonomous traveling function 1000 of the ego vehicle, since the vehicle must pass through the tollgates and the exit/merge point.

Referring to FIG. 11b, the second payment plan may support the automatic lane change function 1102, and the third payment plan may support the tollgate pass function 1103 and the exit/merge function 1104.

The autonomous traveling function 1003 required in Route3 may include a traffic light pass function, in addition to the lane keeping function, the speed keeping function, the preceding vehicle distance keeping function, and the AEB, which are included in the possible autonomous traveling function 1000 of the ego vehicle, since the vehicle must pass through the traffic light.

Referring to FIG. 11a, a first payment plan may support the traffic light pass function 1101.

For example, in the case in which Route2 is selected, the required time is the shortest, but stability is the lowest. Consequently, it may be necessary to select the third payment plan for completely autonomous traveling. In the case in which Route3 is selected, the required time is the longest, but stability is the highest. Consequently, it may be necessary to select the first payment plan for completely autonomous traveling. In the case in which Route1 is selected, the required time and stability are normal. Consequently, it may be necessary to select the second payment plan for completely autonomous traveling.

In the case in which a payment plan less expensive than a payment plan necessary for completely autonomous traveling is selected, the autonomous traveling function required in the traveling environment is not satisfied, whereby a section in which the autonomous traveling function cannot be supported may occur. In the section in which the autonomous traveling function cannot be supported, therefore, manual driving may be required.

For example, in the case in which Route2 and the second payment plan are selected, switching to manual driving may be required when the vehicle passes through the tollgates or the exit/merge point, since the tollgate pass function 1103 and the exit/merge function 1104 are not supported.

FIGS. 11a and 11b are views showing data and an autonomous traveling function provided to the vehicle by payment plan according to an embodiment of the present disclosure.

FIG. 11a is a view showing data provided by each payment plan in order to support the autonomous traveling function. In the case in which the possible autonomous traveling function 1000 of the ego vehicle includes the lane keeping function, the speed keeping function, the preceding vehicle distance keeping function, and the AEB, the provided data may include lane (route) information, speed limit information, and surrounding vehicle information (front).

The first payment plan may provide at least one type of positioning data 1110 selected from among ego vehicle position data, traffic light signal data, tollgate position data, and exit/merge position data in order to support the traffic light pass function 1101.

In the case in which the communication payment plan is set to the first payment plan by user selection, traveling-related data received through communication with the external server 300 may be at least one type of positioning data selected from among the ego vehicle position data, the traffic light signal data, the tollgate position data, and the exit/merge position data.

The second payment plan may provide surrounding vehicle information (side) and surrounding vehicle information (rear) 1120 in order to support the automatic lane change function 1102.

In the case in which the communication payment plan is set to the second payment plan by user selection, traveling-related data received through communication with the external server 300 may be data about a surrounding vehicle including the side rear thereof for automatic lane change.

The third payment plan may provide surrounding environment data 1130 in order to support the tollgate pass function 1103 and the exit/merge function 1104.

In the case in which the communication payment plan is set to the third payment plan by user selection, traveling-related data received through communication with the external server 300 may be data about a surrounding vehicle including the side rear thereof for automatic lane change and data about the surrounding environment for tollgate pass and exit/merge.

FIG. 11b is a view showing a charge of each payment plan and an autonomous traveling function and data provided by each payment plan. The payment plans may have different charges, and may be set by user selection. An autonomous traveling function provided by a payment plan having a high charge and data provided to support the autonomous traveling function may include an autonomous traveling function provided by a payment plan having a low charge and data provided to support the autonomous traveling function.

In the case in which the user selects the first payment plan, data provided to the vehicle from the external server 300 may be at least one type of positioning data 1110 selected from among ego vehicle position data, traffic light signal data, tollgate position data, and exit/merge position data.

In the case in which the user selects the second payment plan, data provided to the vehicle from the external server 300 may be data 1120 about a surrounding vehicle including the side rear thereof for automatic lane change.

In the case in which the user selects the third payment plan, data provided to the vehicle from the external server 300 may be data 1120 about a surrounding vehicle including the side rear thereof for automatic lane change and data 1130 about surrounding environment for tollgate pass and exit/merge.

An autonomous vehicle may perform 5G communication, and may be controlled in the longitudinal direction and in the lateral direction by an external autonomous traveling control signal. Required time and stability information may be calculated through the possible autonomous traveling function 1000 of the ego vehicle and the autonomous traveling functions 1001, 1002, and 1003 required in traveling environments based on the respective routes.

The processor 170 may ask the user about a route and payment plan to be selected through the interface 180.

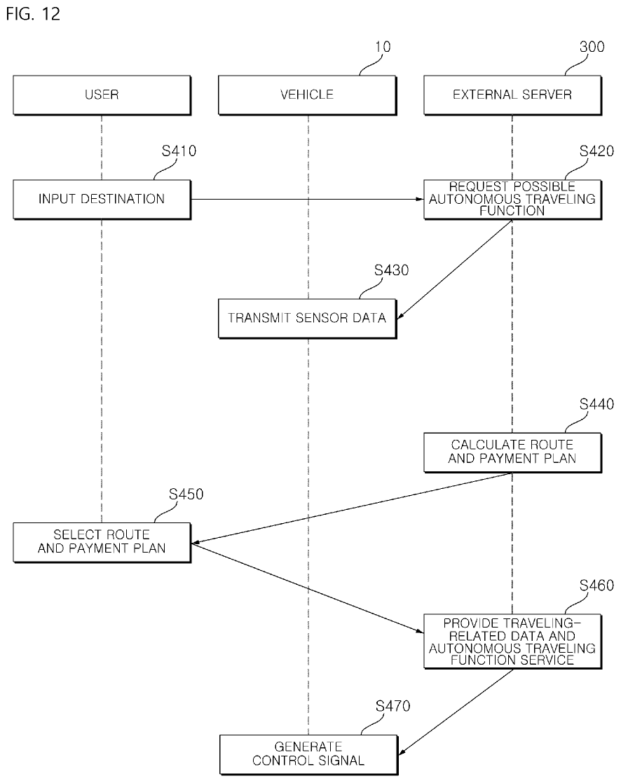

FIG. 12 is a block diagram showing a process of generating an autonomous traveling control signal by subject according to an embodiment of the present disclosure.

Referring to FIG. 12, the process of generating the autonomous traveling control signal may include a step of the user inputting a destination (S410), a step of the external server 300 requesting a possible autonomous traveling function (S420), a step of the vehicle 10 transmitting sensor data (S430), a step of the external server 300 calculating a route and a payment plan (S440), a step of the user selecting the route and the payment plan (S450), and a step of the external server 300 providing traveling-related data and an autonomous traveling function service (S460), and a step of the vehicle 10 generating a control signal (S470).

The step of the user inputting the destination (S410) may be performed by an HMI module 20 and the autonomous traveling system administration module 103 of the autonomous vehicle system, and the step of the external server 300 requesting the possible autonomous traveling function (S420) may be performed by the autonomous traveling system administration module 315 and the possible autonomous traveling function determination module 319 of the external server 319.

The external server 300 may calculate the route and the payment plan as follows. The external server 300 may determine a possible autonomous traveling function of the ego vehicle, may generate all routes to a destination, may determine an autonomous traveling function required for each section on each route, may compare the possible autonomous traveling function of the ego vehicle with the autonomous traveling function required for each section to determine an autonomous traveling function that is additionally necessary by route, and may calculate the route and the payment plan based on the autonomous traveling function that is additionally necessary.

The possible autonomous traveling function of the ego vehicle may be determined by the external server 300 through the possible autonomous traveling function determination module 319 based on at least one of the construction of the sensor mounted in the ego vehicle, the construction of the autonomous traveling algorithm, road environment, or weather environment.

The step of calculating the route to the input destination and the payment plan (S440) may be performed by the autonomous traveling system administration module 315, the route generation module 316, and the possible autonomous traveling function determination module 319 of the external server 300, and the step of the user selecting the route and the payment plan (S450) may be performed by the HMI module 20 and the autonomous traveling system administration module 103 of the autonomous vehicle system.

In the case in which the external server 300 determines that the autonomous traveling function required for each section is not higher than the possible autonomous traveling function of the ego vehicle, the step of the autonomous traveling function service (S460) may be performed by the HD map module 312, the local dynamic map module 313, the autonomous traveling system administration module 315, the vehicle diagnosis module 317, and the danger prediction/determination module 318 of the external server 300.

In the case in which the external server 300 determines that the autonomous traveling function required for each section is higher than the possible autonomous traveling function of the ego vehicle, this step may be performed by the HD map module 312, the local dynamic map module 313, the determination/control module 314, the autonomous traveling system administration module 315, the vehicle diagnosis module 317, and the danger prediction/determination module 318 of the external server 300.

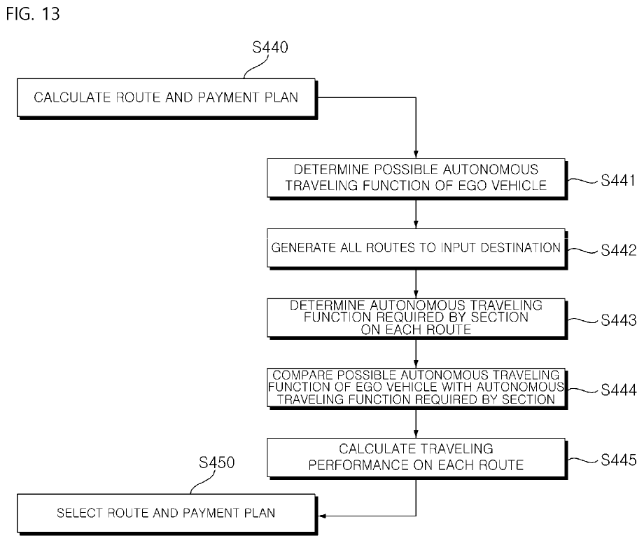

FIG. 13 is a block diagram showing a route and payment plan calculation method according to an embodiment of the present disclosure.

Referring to FIG. 13, the step of calculating the route and the payment plan (S440) may include a step of determining a possible autonomous traveling function of the ego vehicle (S441), a step of generating all routes to an input destination (S442), a step of determining an autonomous traveling function required for each section on each route (S443), a step of comparing the possible autonomous traveling function of the ego vehicle with the autonomous traveling function required for each section (S444), and a step of calculating traveling performance on each route (S445).

At the step of generating all routes to the input destination (S442), all routes (global paths) to the destination may be generated through the HMI module 20, the HD map module 312, and the route generation module 316. At the step of determining the autonomous traveling function required for each section on each route (S443), a function necessary for autonomous traveling by route may be determined by the possible autonomous traveling function determination module 319 based on road environment information and weather environment information obtainable through the HD map module 312.

At the step of comparing the possible autonomous traveling function of the ego vehicle with the autonomous traveling function required for each section on each route (S444), the possible autonomous traveling function of the ego vehicle may be collected and compared with the autonomous traveling function required for each section on each route by the autonomous traveling system administration module 315 and the possible autonomous traveling function determination module 319 through the construction of the sensor and the algorithm of the vehicle 10.

At the step of calculating the traveling performance (S445), traveling performance by route may be calculated by the possible autonomous traveling function determination module 319 and the HD map module 312 based on the required traveling time and traveling distance by route, the expected number of driver interventions, and autonomous traveling function failure statistics.

At the step of calculating the route and the payment plan (S440), a payment plan necessary by route may be calculated by the possible autonomous traveling function determination module 319 based on the traveling performance. The user may select a route and a payment plan through the HMI module 20 (S450), and, in the case in which the payment plan selected by the user is less expensive than a payment plan necessary for completely autonomous traveling, manual driving may be required in a section of the selected route in which the autonomous traveling function cannot be supported.

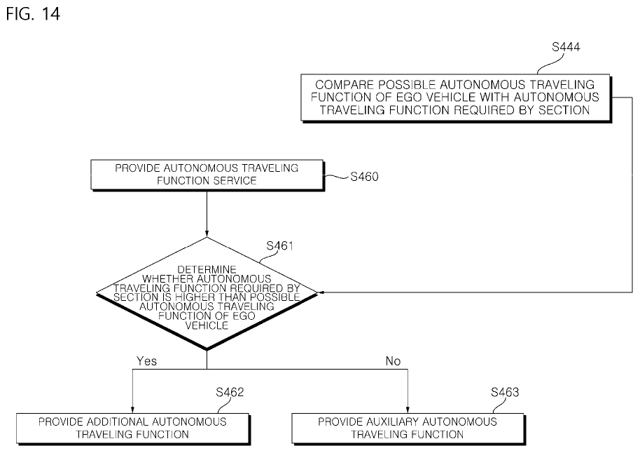

FIG. 14 is a block diagram showing an autonomous traveling function service provision method of a communication company system according to an embodiment of the present disclosure.

Referring to FIG. 14, when the user selects a route and a payment plan (S450), the external server 300 may provide an autonomous traveling function necessary based on the selected route and payment plan.

At the step of providing the autonomous traveling function service (S460), it may be determined whether the autonomous traveling function required for each section is higher than the possible autonomous traveling function of the ego vehicle (S461), an additional autonomous traveling function may be provided upon determining that the autonomous traveling function required for each section is higher than the possible autonomous traveling function of the ego vehicle (S462), and an auxiliary autonomous traveling function may be provided upon determining that the autonomous traveling function required for each section is lower than the possible autonomous traveling function of the ego vehicle (S463).

The step of determining whether the autonomous traveling function required for each section is higher than the possible autonomous traveling function of the ego vehicle (S461) may use the result of the step of comparing the possible autonomous traveling function of the ego vehicle with the autonomous traveling function required for each section (S444).

In the communication-based integrated mode 100d, the additional autonomous traveling function may be provided. In the communication-based integrated mode 100d, the external server 300 may provide an additional autonomous traveling function that is additionally necessary and an autonomous traveling control signal having secured redundancy.

In the sensor-based integrated mode 100b, the auxiliary autonomous traveling function may be provided. In the sensor-based integrated mode 100b, the external server 300 may provide an auxiliary autonomous traveling function that assists the possible autonomous traveling function of the ego vehicle at an auxiliary level.

FIGS. 15a and 15b are views showing an additional autonomous traveling function or an auxiliary autonomous traveling function by payment plan.

Referring to FIG. 15a, in the case in which the additional autonomous traveling function is provided (S462), the possible autonomous traveling function of the ego vehicle may include LKA and ACC (also identical in the case in which there is no additional charge 462a). The user may select the communication-based integrated mode 100d, and may select a payment plan. The payment plan may be divided into a minimum payment plan 462b, an intermediate payment plan 462c, and a high-class payment plan 462d.

The communication-based integrated mode 100d is an integrated mode when no high-performance sensor is mounted in the vehicle 10. In the case in which the level of the possible autonomous traveling function of the ego vehicle based on data sensed by the sensor mounted in the vehicle 10 is not high and thus traveling performance is low, the vehicle may travel in the communication-based integrated mode 100d for autonomous traveling.

For example, in the case in which the possible autonomous traveling function of the ego vehicle includes LKA (Lane Keeping Assist) and ACC (Adaptive Cruise Control), traveling performance is low, and therefore the vehicle may travel in the communication-based integrated mode 100d for autonomous traveling.

In the case in which the user selects the minimum payment plan 462b, the additional autonomous traveling function may include TJP, and traveling performance may be normal. In the case in which the user selects the intermediate payment plan 462c, the additional autonomous traveling function may include TJP and manual trigger LCA, and traveling performance may be normal. In the case in which the user selects the intermediate payment plan 462c, the additional autonomous traveling function may include TJP, automatic trigger LCA, and Exit/Merge, and traveling performance may be high.

In the case in which the auxiliary autonomous traveling function is provided (S463), the possible autonomous traveling function of the ego vehicle may include LKA, ACC, TJP, LCA, and Exit/Merge (also identical in the case in which there is no additional charge 463a). The user may select the sensor-based integrated mode 100d, and may select a payment plan. A basic payment plan 463b may be selected as the payment plan.

The sensor-based integrated mode 100b may be an integrated mode when a high-performance sensor is mounted in the vehicle 10. In the case in which the level of a possible autonomous traveling function of an ego vehicle based on data sensed by the sensor mounted in the vehicle 10 is high and thus traveling performance is high, the vehicle may travel in the sensor-based integrated mode 100b for autonomous traveling.

For example, in the case in which the possible autonomous traveling function of the ego vehicle includes LKA (Lane Keeping Assist), ACC (Adaptive Cruise Control), TJP (Traffic Jam Pilot), LCA (Lane Change Assist), and Exit/Merge, traveling performance is high, and therefore the vehicle may travel in the sensor-based integrated mode 100b for autonomous traveling.

In the case in which the user selects the basic payment plan 463b, an extended multi-object tracking (MOT) function and a downtown area supporting function (traffic light and pedestrian information) may be additionally supported to assist the possible autonomous traveling function of the ego vehicle, whereby traveling performance may be improved.

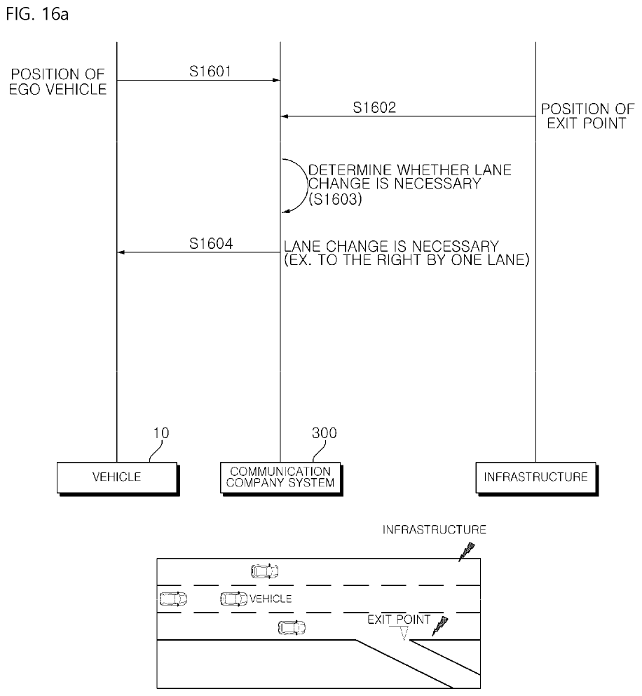

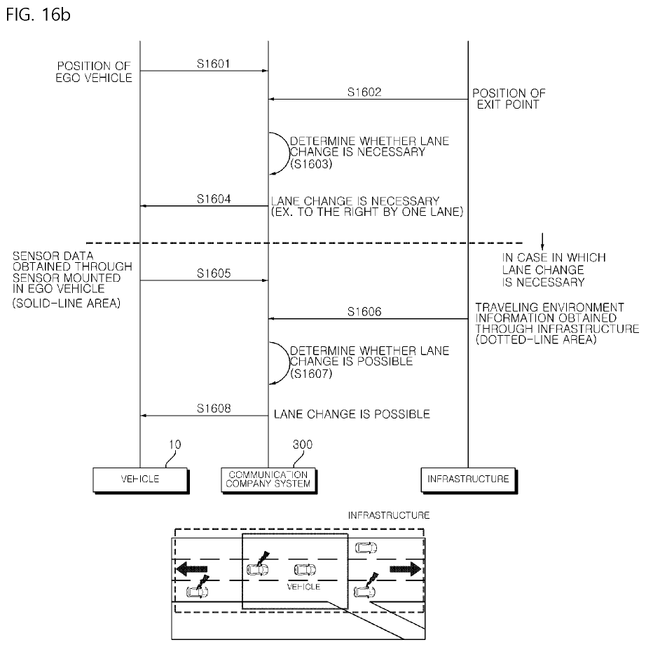

FIGS. 16a and 16b are views showing a process of determining whether lane change is necessary and possible by subject according to an embodiment of the present disclosure.

Referring to FIGS. 16a and 16b, the vehicle 10 may determine whether lane change is necessary and whether lane change is possible based on data provided to the vehicle 10 from the external server 300, and may utilize an automatic trigger lane change function in a vehicle that supports only a manual trigger lane change function based on determination as to whether lane change is necessary and whether lane change is possible.

Through 5G communication, the vehicle 10 transmits the position of the ego vehicle to the external server 300 (S1601), and the external server 300 receives information about the position of an exit point through infrastructure (S1602) and determines whether lane change is necessary (S1603). Upon determining that lane change is necessary, for example, the external server transmits a signal for changing lanes to the right by one lane to the vehicle 10 (S1604).

When lane change is necessary, the vehicle 10 transmits sensor data obtained through the sensor mounted in the ego vehicle to the external server 300 (S1605), and the external server 300 receives traveling environment information obtained through infrastructure (S1605) and determines whether lane change is possible (S1607). Upon determining that lane change is possible, the external server transmits a signal for changing lanes to the vehicle 10, and, upon determining that lane change is not possible, the external server transmits a signal for not changing lanes to the vehicle 10 (S1608).

Surrounding vehicle information may not be sufficient in an area that the sensor mounted in the ego vehicle is capable of recognizing, whereby it may be difficult for the vehicle 10 to determine whether lane change is possible. In contrast, in the case in which data are received from the external server 300 through infrastructure, the recognition area may be extended, whereby it is possible for the vehicle 10 to determine whether lane change is possible.

That is, the operation requiring driver intervention (determination as to whether lane change is necessary and whether lane change is possible) may be performed by the external server 300, rather than by the driver, whereby it is possible to support an automatic trigger lane change function in a vehicle that supports only a manual trigger lane change function.

Data provided to the vehicle 10 from the external server 300 may include surrounding environment information, such as preceding vehicle flow status information, traffic light information, information about the correct position of the ego vehicle, and correct surrounding object information, which is more correct than information obtainable through the sensor, and a downtown area-based autonomous traveling function may be supported in a vehicle that supports only an expressway-based autonomous traveling function based on the data provided to the vehicle 10 from the external server 300.

The present disclosure as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disc, and an optical data storage device. In addition, the computer-readable medium may be implemented as a carrier wave (e.g. data transmission over the Internet). In addition, the computer may include a processor or a controller. Thus, the above detailed description should not be construed as being limited to the embodiments set forth herein in all terms, but should be considered by way of example. The scope of the present disclosure should be determined by the reasonable interpretation of the accompanying claims and all changes in the equivalent range of the present disclosure are intended to be included in the scope of the present disclosure.

1. An electronic device for vehicles, the electronic device comprising:
an interface; and
a processor configured:
to generate an autonomous traveling control signal based on sensor data sensed by a sensor mounted in a vehicle in a sensor autonomous traveling mode;
to generate an autonomous traveling control signal based on the sensor data and traveling-related data received through communication with an external server in an integrated mode; and
to switch between the sensor autonomous traveling mode and the integrated mode based on a user input signal received through the interface.

2. The electronic device according to claim 1, wherein
the external server is a server of a communication company system that supports a 5G-based autonomous traveling service, and
the communication uses 5G communication.

3. The electronic device according to claim 1, wherein the processor is configured:
in the sensor autonomous traveling mode,
to receive the sensor data through the interface;
to determine a possible autonomous traveling function of an ego vehicle based on the sensor data; and
to generate the autonomous traveling control signal based on the possible autonomous traveling function of the ego vehicle.

4. The electronic device according to claim 1, wherein the traveling-related data received through communication with the external server, in the integrated mode, are generated by the external server receiving the sensor data from the processor and comparing the possible autonomous traveling function of the ego vehicle based on the sensor data with an autonomous traveling function required for each section.

5. The electronic device according to claim 4, wherein
when the external server determines that the autonomous traveling function required for each section is not higher than the possible autonomous traveling function of the ego vehicle,
the traveling-related data are first data, which are data for providing an auxiliary autonomous traveling function that assists the possible autonomous traveling function of the ego vehicle, and
the first data are generated through an environment information module and an autonomous traveling system administration module of the external server.

6. The electronic device according to claim 5, wherein the processor is configured:
to determine the possible autonomous traveling function of the ego vehicle and the auxiliary autonomous traveling function based on the sensor data and the first data; and
to generate the autonomous traveling control signal based on the possible autonomous traveling function of the ego vehicle and the auxiliary autonomous traveling function.

7. The electronic device according to claim 1, wherein the traveling-related data received through communication with the external server, in the integrated mode, are changed depending on a communication payment plan, and
wherein the communication payment plan is set by user selection through the interface based on a result of calculation of a payment plan by route performed by the external server.

8. The electronic device according to claim 7, wherein the traveling-related data, when the communication payment plan is set to a basic payment plan, is traveling environment information that is at least one of HD map information or local dynamic map information generated by the external server based on the sensor data received from the processor.

9. An electronic device for vehicles of an autonomous vehicle controllable in a longitudinal direction and in a lateral direction by an external signal, the electronic device comprising:
an interface; and
a processor configured:
to generate an autonomous traveling control signal based on traveling-related data received through communication with an external server in a communication autonomous traveling mode;
to generate an autonomous traveling control signal based on the traveling-related data and sensor data sensed by a sensor mounted in the vehicle in an integrated mode; and
to switch between the communication autonomous traveling mode and the integrated mode based on a user input signal received through the interface.

10. The electronic device according to claim 9, wherein
the external server is a server of a communication company system that supports a 5G-based autonomous traveling service, and
the communication uses 5G communication.

11. The electronic device according to claim 9, wherein the traveling-related data received through communication with the external server, in the communication autonomous traveling mode, are external signal data capable of controlling autonomous traveling of the vehicle generated through an environment information module, an autonomous traveling system administration module, and a determination/control module of the external server, and
wherein the processor is configured to receive the external signal data in order to generate the autonomous traveling control signal without operation of the sensor mounted in the vehicle.

12. The electronic device according to claim 9, wherein the traveling-related data received through communication with the external server, in the integrated mode, are generated by the external server receiving the sensor data from the processor and comparing a possible autonomous traveling function of an ego vehicle based on the sensor data with an autonomous traveling function necessary for traveling to a destination.

13. The electronic device according to claim 12, wherein
when the external server determines that the autonomous traveling function necessary for traveling to the destination is higher than the possible autonomous traveling function of the ego vehicle,
the traveling-related data are second data, which are data for providing an additional autonomous traveling function that is added to the possible autonomous traveling function of the ego vehicle and external signal data capable of controlling autonomous traveling of the vehicle, which are generated based thereon, and
the second data are generated through an environment information module, an autonomous traveling system administration module, and a determination/control module of the external server.

14. The electronic device according to claim 13, wherein the processor is configured:
to determine the possible autonomous traveling function of the ego vehicle and the additional autonomous traveling function based on the sensor data and the second data; and
to generate the autonomous traveling control signal based on the possible autonomous traveling function of the ego vehicle and the additional autonomous traveling function.

15. The electronic device according to claim 9, wherein the traveling-related data received through communication with the external server, in the integrated mode, are changed depending on a communication payment plan, and
wherein the communication payment plan is set by user selection through the interface based on a result of calculation of a payment plan by route performed by the external server.

16. The electronic device according to claim 15, wherein the traveling-related data, when the communication payment plan is set to a first payment plan, are at least one selected from among ego vehicle position data, traffic light signal data, tollgate position data, and exit/merge position data.

17. The electronic device according to claim 15, wherein the traveling-related data, when the communication payment plan is set to a second payment plan, are data about a surrounding vehicle comprising a side rear thereof for automatic lane change.

18. The electronic device according to claim 15, wherein the traveling-related data, when the communication payment plan is set to a third payment plan, are data about a surrounding vehicle comprising a side rear thereof for automatic lane change and data about surrounding environment for tollgate pass and exit/merge.

19. The electronic device according to claim 15, wherein the payment plan by route is obtained by the external server determining a possible autonomous traveling function of an ego vehicle, generating all routes to a destination, determining an autonomous traveling function required for each section on each route, comparing the possible autonomous traveling function of the ego vehicle with the autonomous traveling function required for each section to determine an autonomous traveling function that is additionally necessary by route, and calculating the payment plan based on the autonomous traveling function that is additionally necessary.

20. The electronic device according to claim 19, wherein the possible autonomous traveling function of the ego vehicle is determined by the external server through a possible autonomous traveling function determination module based on at least one of construction of a sensor mounted in the ego vehicle, construction of an autonomous traveling algorithm, road environment, or weather environment.
